(19) United States
(12) Patent Application Publication
(10) Pub. No.: US 2006/0232406 A1
(43) Pub. Date: Oct. 19, 2006

(54) USE OF RF-ID TAGS FOR TRACKING A PERSON CARRYING A PORTABLE RF-ID TAG READER

(75) Inventor: Michael W. Filibeck, Long Beach, CA (US)

Correspondence Address: NOVAK DRUCE & QUIGG, LLP, 1300 EYE STREET NW, 400 EAST TOWER, WASHINGTON, DC, 20005, US

(73) Assignee: AMERICAN RESEARCH AND TECHNOLOGY, Century City, CA (US)

(21) Appl. No.: 10/907,735

(22) Filed: Apr. 13, 2005

(51) Int. Cl. G08B 13/14

(52) U.S. Cl. 340/572.1; 340/539.13; 340/825.49

(57) ABSTRACT

For tracking a person such as a security guard at a construction site, RF-ID tags are placed at a plurality of locations at the site. The person carries a portable RF-ID tag reader while visiting at least some of the locations, and the portable RF-ID tag reader detects the presence of the RF-ID tags at these locations and reads tag identifiers identifying these locations. The person is tracked by monitoring a sequence of the tag identifiers read by the portable RF-ID tag reader. For example, the person also carries an Internet capable cell telephone that transmits the tag identifiers over the Internet to a computer at a location remote from the site, and the computer detects when the person deviates from an assigned path at the site.

### LIMITED COPYRIGHT WAIVER

A portion of the disclosure of this patent document contains computer display formats to which the claim of copyright protection is made. The copyright owner has no objection to the facsimile reproduction by any person of the patent document or the patent disclosure, as it appears in the U.S. Patent and Trademark Office patent file or records, but reserves all other rights whatsoever.

### FIELD OF THE INVENTION

The present invention relates generally to security management, and more particularly to use of RF-ID tags for security management.

### BACKGROUND OF THE INVENTION

RF-ID tags are typically used for identifying objects, vehicles, or persons. The RF-ID tag contains a microchip and an RF transmitter or transceiver. The microchip is programmed with a tag identifier such as a tag number, and often additional information identifying the object, vehicle, or person. The RF-ID tag is placed upon the object or vehicle, or placed in a badge or card carried by the person. An RF-ID tag reader can read the tag identifier and any of the additional information from the tag when the tag is in the neighborhood of the reader. Often the RF-ID tag reader will transmit the tag identifier and any other information read from the tag to a host computer.

Tag readers have been used not only for identifying tagged objects but also for tracking tagged objects. To track a tagged object, a number of tag readers have been placed along the path of the tagged object. In this fashion, particular objects in a stream of objects have been tracked as they move though checkpoints.

### SUMMARY OF THE INVENTION

In accordance with one aspect, the invention provides a method of tracking a person. The method includes placing an RF-ID tag at each of a plurality of locations, the RF-ID tag having a tag identifier identifying the location. The method further includes the person carrying a portable RF-ID tag reader while visiting at least some of the locations, the portable RF-ID tag reader detecting the presence of the RF-ID tags at these locations and reading the tag identifiers identifying these locations. The method further includes monitoring a sequence of the tag identifiers read by the portable RF-ID tag reader in order to track the person.

In accordance with another aspect, the invention provides a method of employing a security officer at a site. The method includes placing an RF-ID tag at each of a plurality of locations at the site, the RF-ID tag at each location having a tag identifier identifying the location. The method further includes the security officer carrying a portable RF-ID tag reader while visiting at least some of the locations, the portable RF-ID tag reader detecting the presence of the RF-ID tags at these locations and reading the tag identifiers identifying these locations. The method further includes using a computer to monitor a sequence of the tag identifiers read by the portable RF-ID tag reader.

In accordance with yet another aspect, the invention provides apparatus for tracking a person including a portable RF-ID tag reader and a cell telephone for carrying by the person while the person walks along a path including RF-ID tags at respective locations. The RF-ID tag reader is coupled to the cell telephone for transmitting tag identifiers to the cell telephone, and the cell telephone is programmed for transmitting the RF-ID tag identifiers to a computer programmed for monitoring the tag identifiers received from the cell telephone in order to track the person.

### BRIEF DESCRIPTION OF THE DRAWINGS

Additional features and advantages of the invention will be described below with reference to the drawings, in which:

FIG. 1 is a block diagram of an on-line security management system in accordance with the present invention;

FIG. 2 is a block diagram showing details of a client site in the on-line security management system of FIG. 1;

FIG. 3 is a flow chart of a basic condition sensing and reporting procedure executed by a computer at the client site;

FIG. 4 is a flow chart of a procedure executed by an on-line security management server in the system of FIG. 1 for responding to a failure of a security officer to visit a check point at the client site;

FIG. 5 shows various data structures in the on-line security management server for management of scheduled events;

FIG. 6 is a flow chart of a basic procedure executed by the on-line security management server for management of scheduled events;

FIG. 7 is a block diagram of various databases and programs in memory of the on-line server for security management;

FIG. 8 shows a main menu screen of a graphical user interface for Internet access of an administrative user to the on-line server;

FIG. 9 shows the graphical user interface presenting a list of sub-menu items to the administrator in response to the administrator's selection of the “User Management” main menu item;

FIG. 10 shows the graphical user interface responding to the administrator's selection of the “Manage User” sub-menu item;

FIG. 11 shows the main and sub-menu items presented by the graphical user interface to an administrator;

FIG. 12 shows the main and sub-menu items typically presented by the graphical user interface to a supervisor;

FIG. 13 shows the main and sub-menu items typically presented by the graphical user interface to a security officer;

FIG. 14 shows the main and sub-menu items typically presented by the graphical user interface to a client user;

FIG. 15 shows a form used by the graphical user interface for input of information about a user;

FIG. 16 shows a form used by the graphical user interface for assignment of a supervisor to a site;

FIGS. 17 and 18 show a form used by the graphical user interface for assignment of rights to a supervisor;

FIG. 19 shows a form used by the graphical user interface for adding or editing a client call list;

FIG. 20 shows a form used by the graphical user interface for adding or editing a service call list;

FIG. 21 shows a form used by the graphical user interface for adding or editing a specification for a key;

FIG. 22 shows a form used by the graphical user interface for editing a specification for a ring of keys;

FIG. 23 shows a form used by the graphical user interface for authorizing issuance of a key to an employee;

FIG. 24 shows a form used by the graphical user interface for adding shift slots;

FIG. 25 shows a form used by the graphical user interface for assigning a shift to a user;

FIG. 26 shows a form used by the graphical user interface for displaying user details;

FIG. 27 shows a form used by the graphical user interface for displaying a site schedule;

FIG. 28 shows a form used by the graphical user interface for creating or editing identifiers for a vehicle;

FIG. 29 shows a form used by the graphical user interface for creating or editing identifiers for an action taken;

FIG. 30 shows a form used by the graphical user interface for adding or editing a training type;

FIG. 31 shows a form used by the graphical user interface for viewing a log report;

FIG. 32 shows a form used by the graphical user interface for viewing or printing a visitor report;

FIG. 33 shows a print-out of various kinds of reports;

FIG. 34 shows a form used by the graphical user interface for sending a message;

FIG. 35 shows a form used by the graphical user interface for showing a list of messages;

FIG. 36 shows a form used by the graphical user interface for showing a received message;

FIG. 37 shows a form used by the graphical user interface for showing a system setting;

FIG. 38 is a flowchart showing escalation in connection with a call list;

FIG. 39 shows a security officer's Internet capable cell phone being used as a client site computer in connection with an RF-ID tag reader and RF-ID tags that specify respective check points; and

FIG. 40 is a flowchart of basic programming of the Internet capable cell phone in FIG. 39; and

FIG. 41 is a flowchart of more complex programming that could be used for a cell phone that is not Internet capable at the client site of FIG. 39.

While the invention is susceptible to various modifications and alternative forms, a specific embodiment thereof has been shown in the drawings and will be described in detail. It should be understood, however, that it is not intended to limit the invention to the particular form shown, but on the contrary, the intention is to cover all modifications, equivalents, and alternatives falling within the scope of the invention as defined by the appended claims.

### DETAILED DESCRIPTION OF THE PREFERRED EMBODIMENT

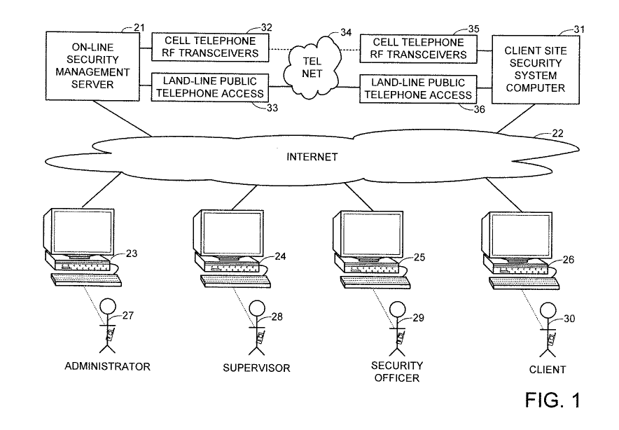

With reference to FIG. 1, there is shown a block diagram of an on-line security management system. The on-line security management system includes a server 21 linked to the Internet for communication via the TCP/IP protocol with a number of user terminals 23, 24, 25, 26. The user terminals access the server 21 using a conventional web browser program such as the Microsoft Internet Explorer (Trademark) program. The user terminals include a terminal 23 for an administrator, a terminal 24 for a supervisor, a terminal 25 for a security officer 29, and a terminal 26 for a client user 30.

In general, the administrator 27 is a person responsible for support and maintenance of software for the on-line security management server 21. The supervisor 28 and the security officer 29 are trained or employed by a company responsible for providing security and guard services. The client user 30 is employed by a company or organization that manages a physical site in need of security services.

The client's physical site includes a client site security system computer 31 that is also liked to the Internet 22 for communication with the on-line server 21 via the Transmission Control Protocol (TCP/IP). For backup in the event of a failure of the Internet connection, the on-line server 31 has conventional dial-up data links to the client site security system computer 31. These conventional dial-up data links include one or more cell phone radio-frequency (RF) transceivers 32 and land-line public telephone access modems 33 at the server site that are linked over the public telephone network 34 to one or more cell phone RF transceivers 35 and land-line telephone access modems 36 at the client site.

The use of the Internet 22 for communication between the on-line security management server 21 and the client site security system computer 31 not only provides faster and more reliable communication but also enables the system to provide new functions and new methods of operation. As will be further described below, the ability of the Internet 22 to maintain a connection between the on-line server 21 and the client site computer 31 enables a method of operation in which the client site computer may request the on-line server to schedule a contingent future event including a need to service a call list unless the client site computer reports a condition warranting the removal of the contingent event from the schedule. Moreover, the ability of the Internet to provide convenient access of the various classes of users to the on-line server 21 permits the integration of virtually all aspects of security system management such as maintenance of call lists and reports, shift management, and supervision and training of security officers.

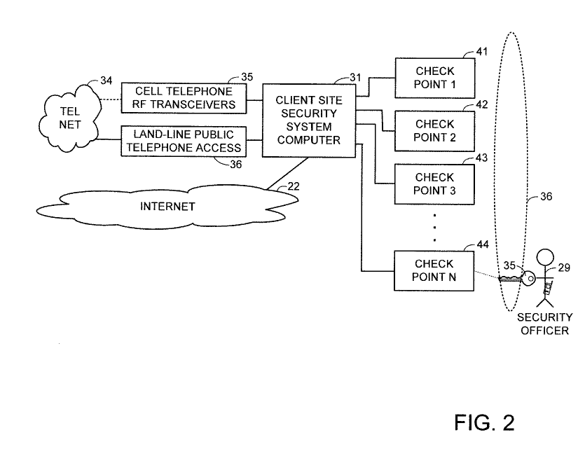

FIG. 2 show details of the client site. Multiple check points 41, 42, 43, 44 are spaced about the client site and linked to the client site system computer. The security officer 29 has a key 35 that can be inserted into a respective key-activated switch at each check point to send a signal to the client site computer 31. In some systems, an electronic badge containing a programmed integrated circuit chip can function in a similar fashion as a key when the badge is placed near a sensor at a check point. In response to the signal, the client site computer 31 makes a record in memory of the particular check point and the time at which the respective key switch was activated. The client site computer also forwards the signal over the Internet 22 to the on-line security management server 21. The security officer 29 walks a pre-assigned path or round 36 in order to visit each of the check points at a respective time in a predetermined sequence.

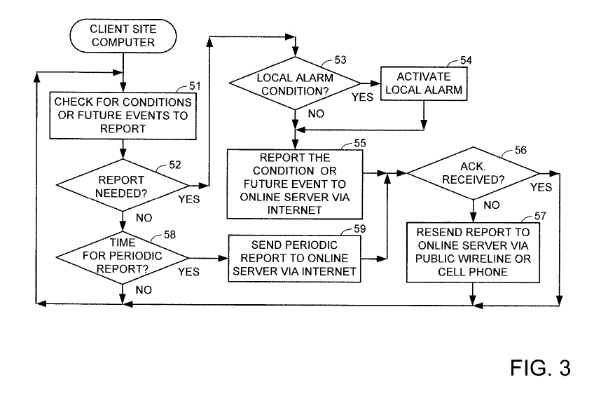

FIG. 3 shows a basic condition sensing and reporting procedure executed by the computer at the client site. In a first step 51, the client site computer checks for conditions or future events to report. The client site computer, for example, checks for sensor signals of abnormal conditions, such as open doors or windows that should be closed, broken glass, and alarm signals from smoke and fire detectors. The client site computer also checks for signals that should normally occur, such as signals from the check points. In step 52, when a report is needed, execution branches to step 53. In step 53, if a signal indicates a local alarm condition, then in step 54, a local alarm is activated, such as a fire alarm in response to an alarm signal from a smoke or fire detector. In step 55, the condition or future event is reported to the on-line server via the Internet. In step 56, if an acknowledgement of the report is not received from the on-line server after a number of re-tries, then in step 57 the report is resent to the on-line server via the public wireline or cell phone modem.

In step 52, if a report is not needed, then execution continues to step 53. In step 53, the client site computer checks whether it is time to send a periodic status report to the on-line computer. In step 59, such a periodic report is sent to the on-line server via the Internet so that the on-line server knows that the client site computer is capable of sending reports of alarm conditions as the need arises.

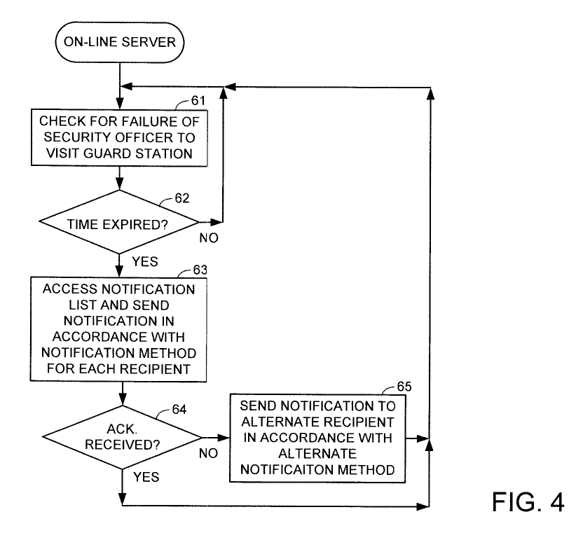

FIG. 4 shows a procedure executed by the on-line security management server for responding to a failure of a security officer to visit a check point at the client site. In a first step 61, the on-line server checks for a failure of a security office to visit a check point. In step 62, if the time for the security officer to visit the check point has expired, then execution continues to step 63. In step 63, the on-line server access a notification list for the particular client site and for the particular condition of interest, and the on-line server sends a notification to each recipient in accordance with a notification method listed for each recipient. For example, the notification list may include, for each listed recipient, a primary notification method such as a land-line or cell telephone number or an E-mail address. In step 64, if the on-line server fails to receive an acknowledgement, such a return sequence of touch tones from a telephone or a return acknowledgement of receipt of the E-mail message, then execution branches to step 65. In step 65, the on-line server sends a notification to an alternate recipient in accordance with an alternate notification method included in the notification list.

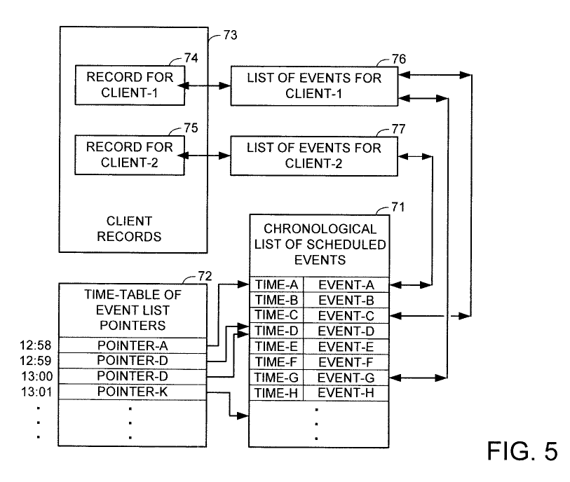

FIG. 5 shows various data structures in the on-line security management server for management of scheduled events. The scheduled events are maintained in a chronological linked-list 71. Each entry in the chronological list 71 identifies the event and a respective time associated with each event. The entries in the chronological list 71 are indexed by respective times, for example, by a time-table 72 of event list pointers. For example, given a particular hour and minute, the time table 72 can be indexed to find a pointer to the next entry in the list that occurs at or after the given hour and minute. Because the on-line server manages security for multiple clients, the scheduled events are also linked to client records 73. A record 74, 75 for each client includes a pointer to a respective list 76, 77 of events for the client. Therefore, given a report from a particular client of a condition for cancellation of an event, the record for the client can be used to find the event to be cancelled.

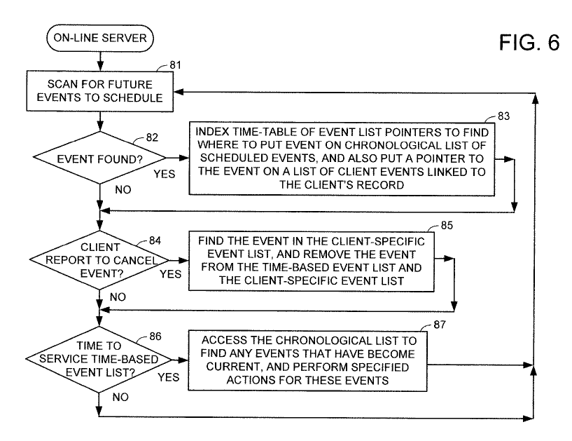

FIG. 6 shows a basic procedure executed by the on-line security management server for management of scheduled events. In a first step 81, the on-line server scans for future events to schedule. For example, in step 81, the on-line server may access a table of the periodic reporting times for the clients, or a queue of requests from the clients for the scheduling of contingent events. In step 82, if an event is found, then execution branches to step 83 to index the time-table of event list pointers to find where to put the event on the chronological list of scheduled events. In step 83, the on-line server also puts a pointer to the event on the list of client events linked to the client's record. Execution continues from step 83 to step 84. Execution also continues from step 82 to step 84 if an event to be scheduled is not found.

In step 84, if the on-line server receives a report of a condition warranting cancellation of a scheduled event, then execution branches to step 85. In step 85, the on-line server finds the event in the client-specific event list, and removes the event from the chronological event list and also from the client-specific event list. Execution continues from step 85 to step 86. Execution also continues from step 84 to step 86 in the absence of a client report to cancel an event.

In step 86, if it is time to service the chronological event list, then execution branches from step 86 to step 87. In step 87, the on-line server accesses the chronological event list to find any events that have become current, and to perform specified actions for these events. After step 87, execution loops back to step 81. Execution also loops back to step 81 from step 86 if it is not yet time to service the chronological event list.

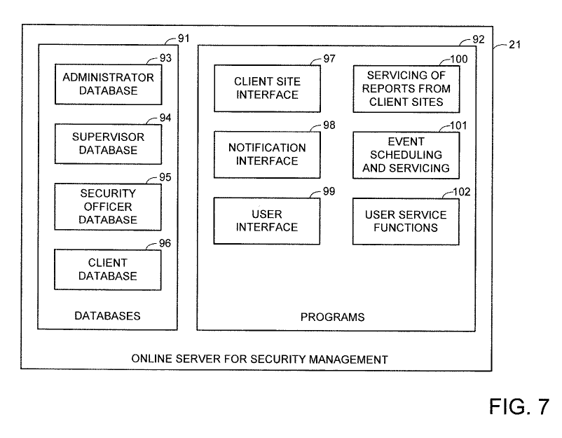

FIG. 7 shows various databases 91 and programs 92 in memory of the on-line server 21. The databases 91 include a database 93 of administrators, a database 94 of supervisors, a database 95 of security officers, and a database 96 of clients. The programs 92 include a client site interface 97 for communicating with a number of client sites, a notification interface 98 for using call lists for notifying users via phone and E-mail about alarm conditions and the occurrence of scheduled events, and a user interface 99 for access to the on-line server 21 via an Internet web browser. The programs 92 further include a program 100 for servicing of reports from client sites, a program 101 for event scheduling and servicing, and a program 102 for user service functions.

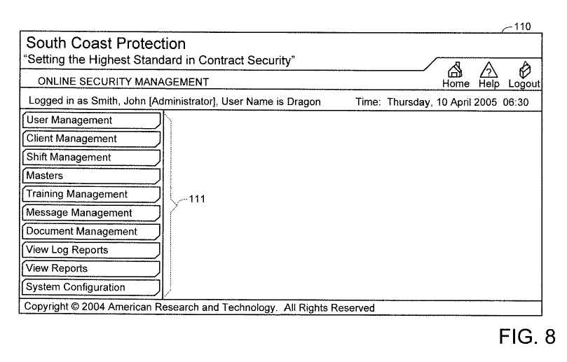

The program 100 determines whether a report signals an alarm condition requiring immediate attention such as alerting the police or fire officials and servicing the client's call list for such alarms, or whether the report requires the scheduling of a future continent event or the cancellation of a scheduled event. The program 101 for event scheduling and servicing is described above generally with respect to FIG. 6 and specifically with respect to the example of FIG. 4. The programs 102 for user service functions collect information for the databases 91 from on-line users and permit the on-line users to view and edit this information in various ways, as further described below with reference to FIGS. 8 to 37.

FIG. 8 shows a main menu screen of a graphical user interface for Internet access of an administrator to the on-line server. The administrator accesses this main menu screen by executing an Internet web browser such as the Microsoft Internet Explorer program, entering a URL of the on-line server, and then entering a username and password. The left-hand side of the main menu screen gives the administrator a list 111 of main menu items including User Management, Client Management, Shift Management, Masters, Training Management, Message Management, Document Management, View Log Reports, View Reports, and System Configuration. In general, each of these main menu items designates a class of service functions for the administrator. By clicking on a main menu item, a list of the service functions in the designated class appears under the selected main menu item. This list of the service functions is presented as a sub-menu.

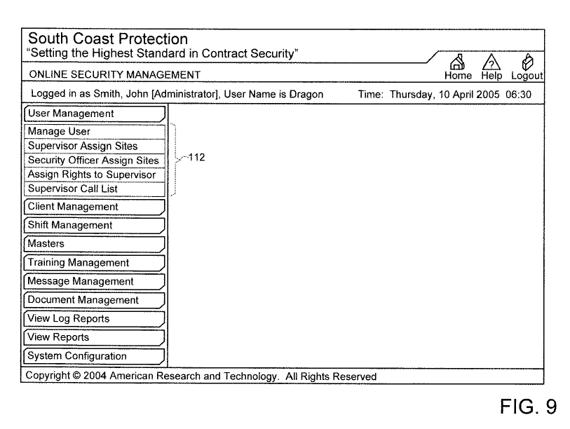

FIG. 9, for example, shows the graphical user interface presenting a list 112 of sub-menu items to the administrator in response to the administrator's selection of the “User Management” main menu item. The list 112 of sub-menu items includes Manage User, Supervisor Assign Sites, Security Officer Assign Sites, Assign Rights to Supervisor, and Supervisor Call List. The administrator can then click on one of the sub-menu items to select a particular on-line service function.

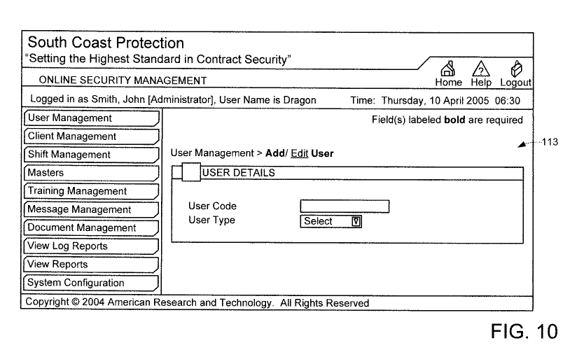

FIG. 10, for example, shows the graphical user interface responding to the administrator's selection of the “Manage User” sub-menu item. The graphical user interface responds to the selection by displaying a form 113 for the service function in the right-hand side of the display screen. The administrator can enter a user code into the form 113 to select an existing user of the on-line system, or the administrator can click on a drop-down menu to select a user type (i.e., administrator, supervisor, security officer, or client) to see and select from a list of users of the particular type.

In general, an administrator has access to all of the on-line service functions, supervisors have access to all of the on-line service functions related to management of the security officers, and security officers and clients have limited access to the service functions.

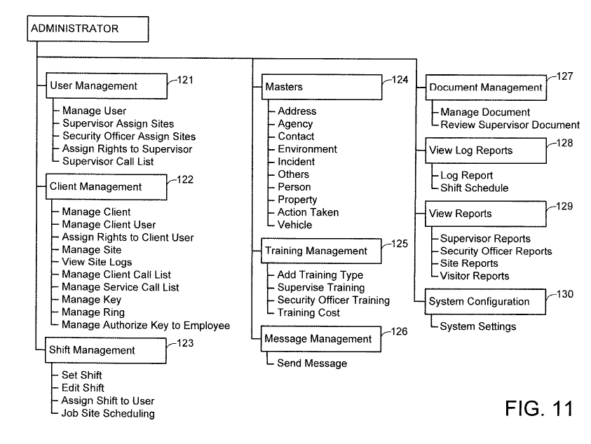

FIG. 11 shows the main and sub-menu items for an administrator. User management 121 involves management of system usernames and passwords for all on-line users, assigning supervisors and security officers to respective client sites, assigning access rights of the supervisors to various ones of the on-line service functions, and the entry and editing of a supervisor call list.

Client management 122 includes the user management of the client and assignment of access rights of the client to various on-line service functions. Client management further includes management of the client's site, access to logs for the client's site, management of a client call list for alarm conditions at the client's site, management of a service call list for services that might be needed at the client's site, management of keys for access to buildings and rooms at the client's site, and managing authorized keys to the client's employees.

Shift management 123 includes setting a shift for a security officer, editing a shift, assigning the shift to a security officer, and scheduling at a job site.

The masters function 124 is performed only by an administrator, and it involves setting up identifiers for various persons, things, or actions relating to security system management. The identifiers appear in the forms and in particular drop-down menus used in the forms. The use of such identifiers facilitates entry of and access to information in the various databases of the on-line security management system.

Training management 125 involves the management of training for the security officers.

Message management 126 involves one user of the on-line system sending a message to another user of the on-line system.

Document management 127 involves supervisors creating documents for viewing by security officers.

View log reports 128 involves viewing reports of basic security officer activities.

View Reports 129 involves viewing various kinds of reports by supervisors and security officers, including reports about a site and reports about visitors to the site.

System configuration 130 involves an administrator viewing or changing system settings that customize the menu screens for a particular security service company.

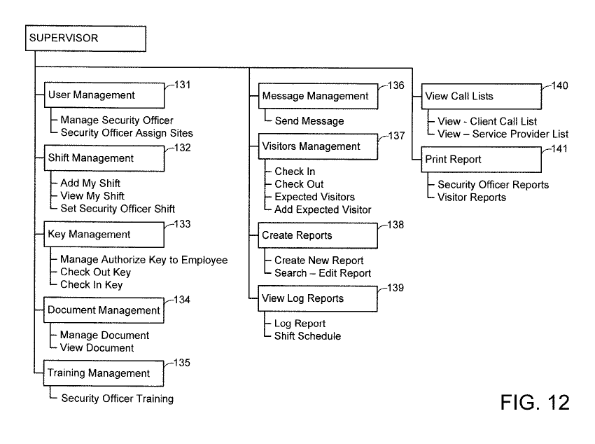

FIG. 12 shows the main and sub-menu items typically presented by the graphical user interface to a supervisor. The main menu items include user management 131, shift management 132, key management 133, document management 134, training management 135, message management 136, visitor management 137, create reports 138, view log reports 139, view call lists 140, and print reports 141.

FIG. 13 shows the main and sub-menu items typically presented by the graphical user interface to a security guard. The main menu items include shift management 151, key management 152, document management 153, message management 154, visitors management 155, create reports 156, view call lists, and print reports 158.

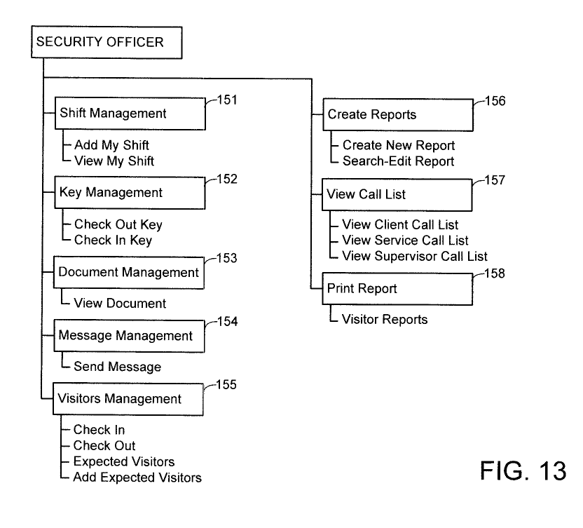

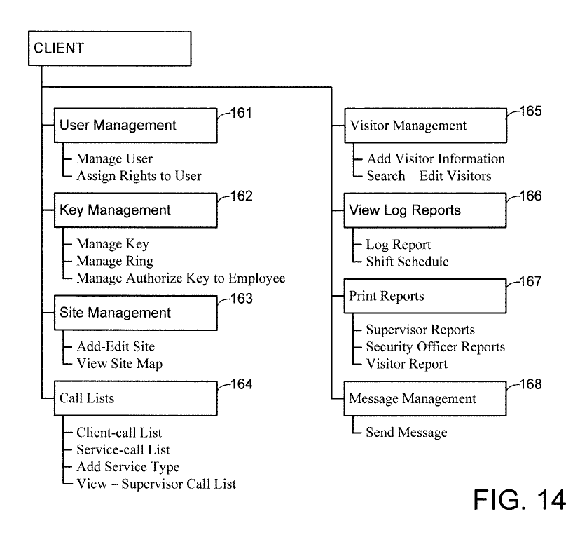

FIG. 14 shows the main and sub-menu items typically presented by the graphical user interface to a client. The main menu items include user management 161, key management 162, site management 163, call lists 164, visitors management 165, view log reports 166, print reports 167, and message management 168.

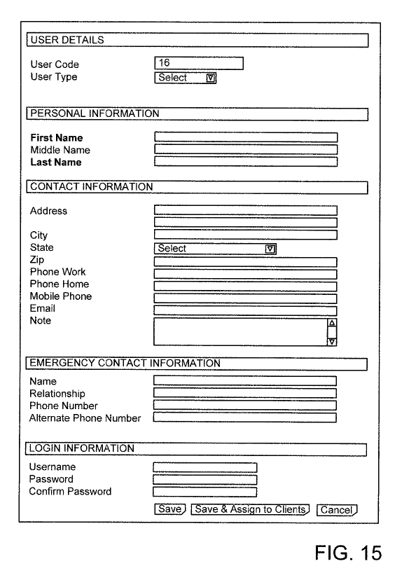

FIG. 15 shows a form used by the graphical user interface for input of information about a user. In this example, a user code 16 has been assigned to a new user, and the form provides fields for entry of information related to the new user, including personal information, contact information, emergency contact information, and login information.

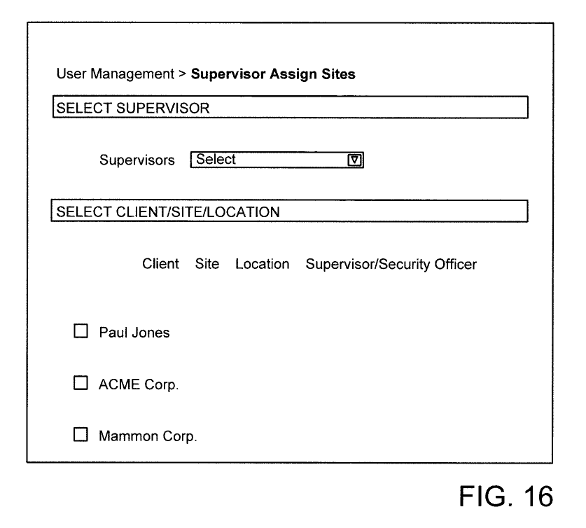

FIG. 16 shows a form used by the graphical user interface for assigning a supervisor to a site.

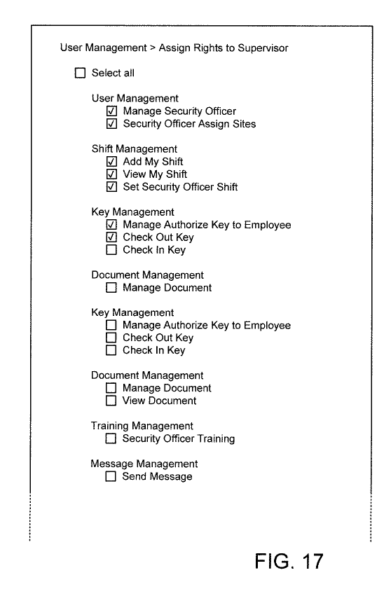

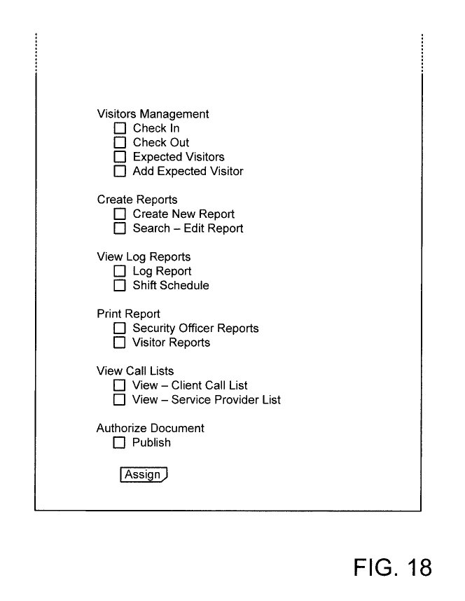

FIGS. 17 and 18 show a form used by the graphical user interface when an administrator assigns rights to a supervisor. The menu of items presented to a particular supervisor is based on the particular rights assigned to the supervisor. Similar kinds of forms are used for assigning rights to security officers and clients.

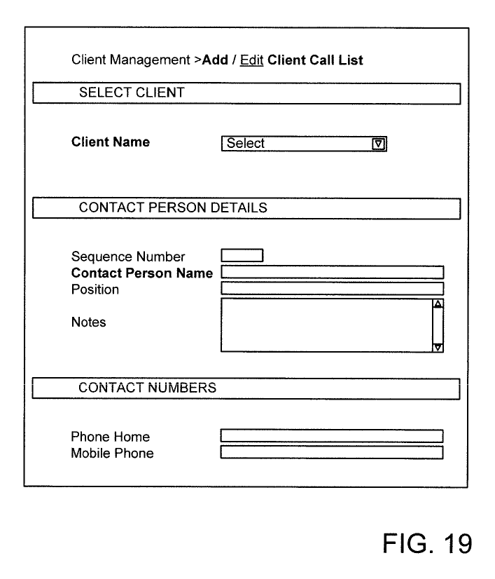

FIG. 19 shows a form used by the graphical user interface for adding or editing a client call list.

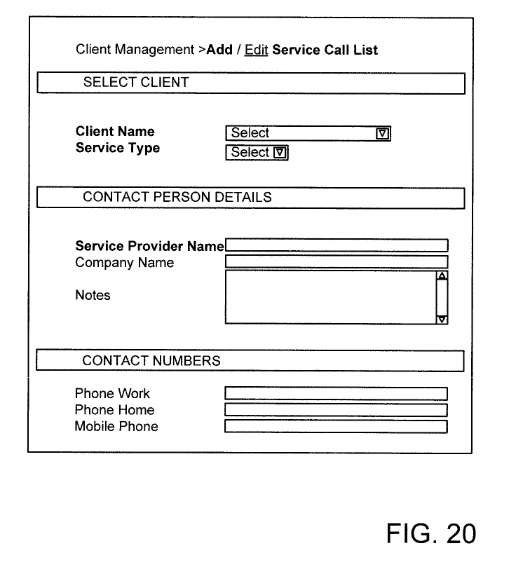

FIG. 20 shows a form used by the graphical user interface for adding or editing a service call list.

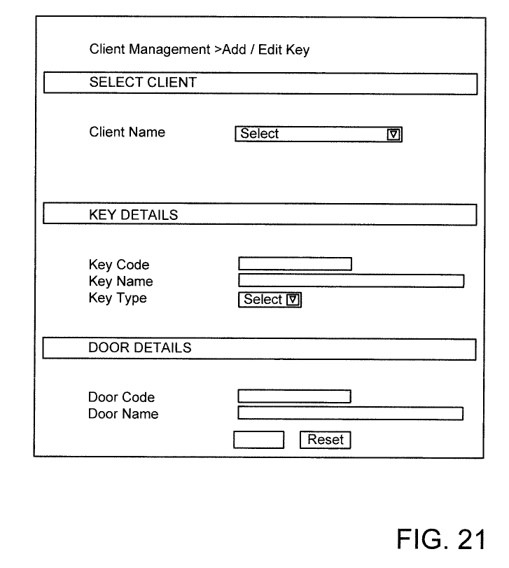

FIG. 21 shows a form used by the graphical user interface for adding or editing a specification for a key.

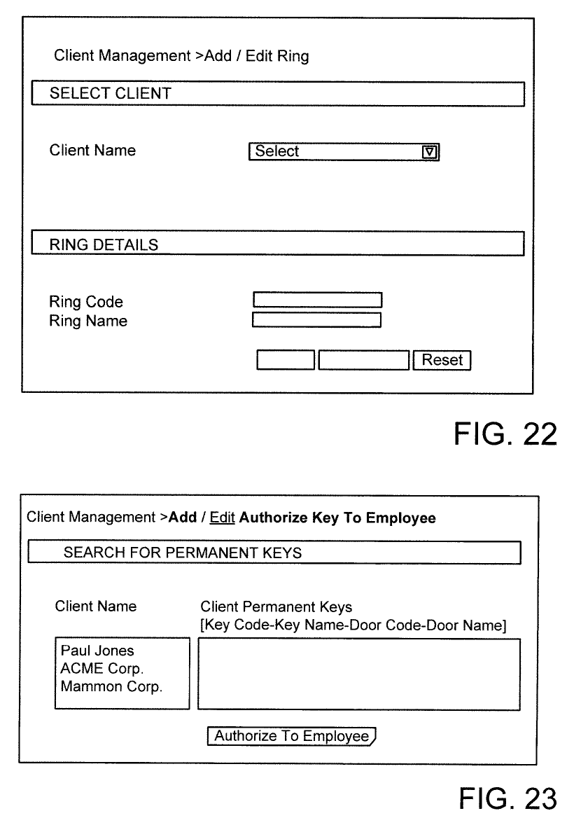

FIG. 22 shows a form used by the graphical user interface for editing a specification for a ring of keys.

FIG. 23 shows a form used by the graphical user interface for authorizing issuance of a key to an employee.

FIG. 24 shows a form used by the graphical user interface for adding shift slots.

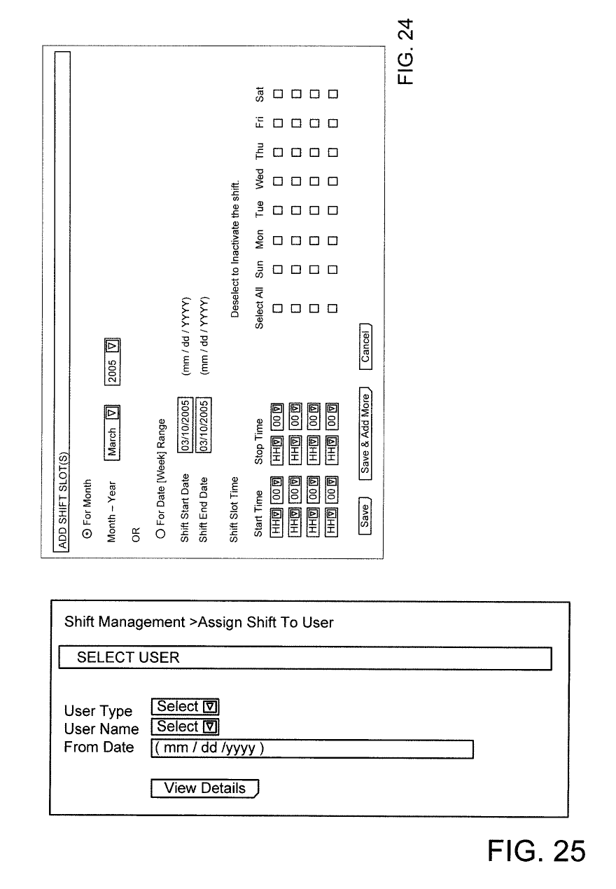

FIG. 25 shows a form used by the graphical user interface for assigning a shift to a user.

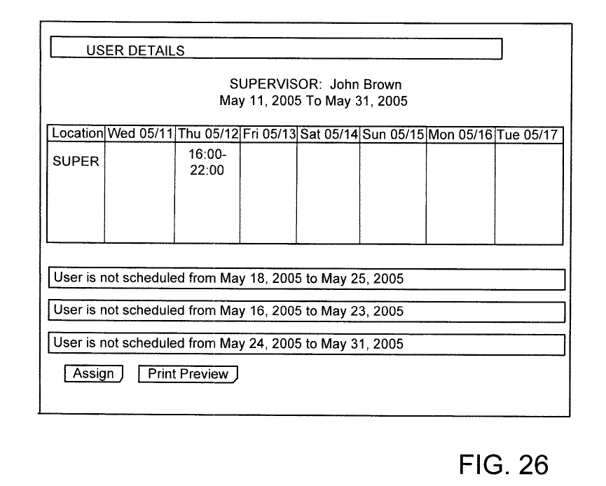

FIG. 26 shows a form used by the graphical user interface for displaying user details;

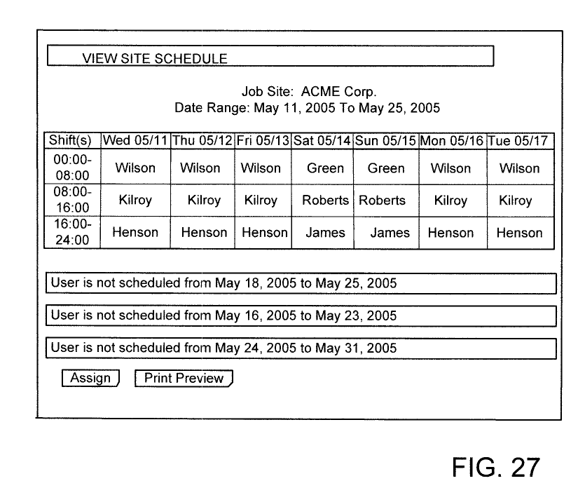

FIG. 27 shows a form used by the graphical user interface for displaying a site schedule.

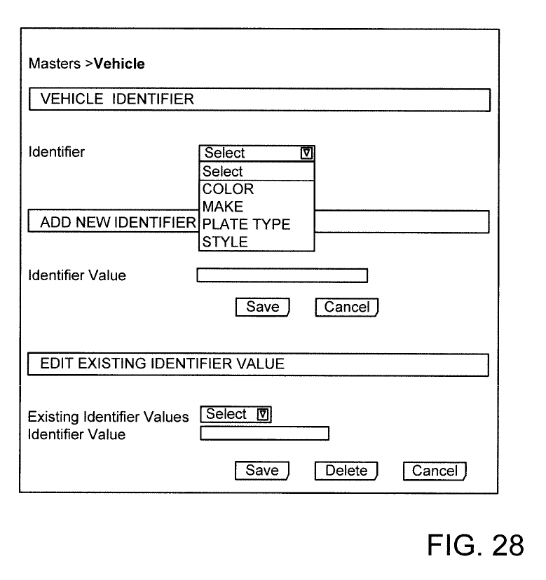

FIG. 28 shows a form used by the graphical user interface for creating or editing identifiers for a vehicle. The identifiers include color, make, plate type, and style.

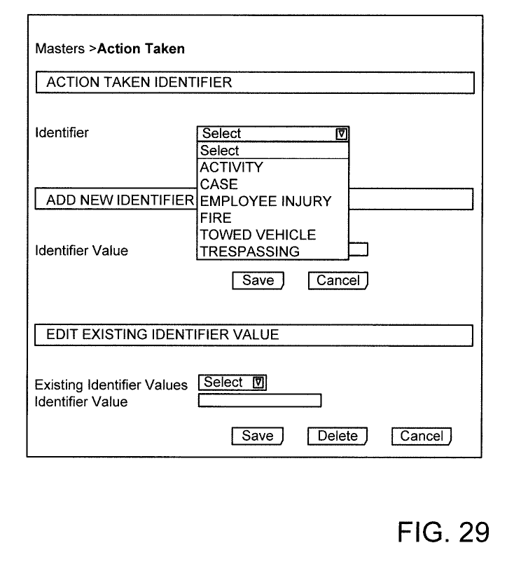

FIG. 29 shows a form used by the graphical user interface for creating or editing identifiers for an action taken. The identifiers include activity, case, employee injury, fire, towed vehicle, and trespassing.

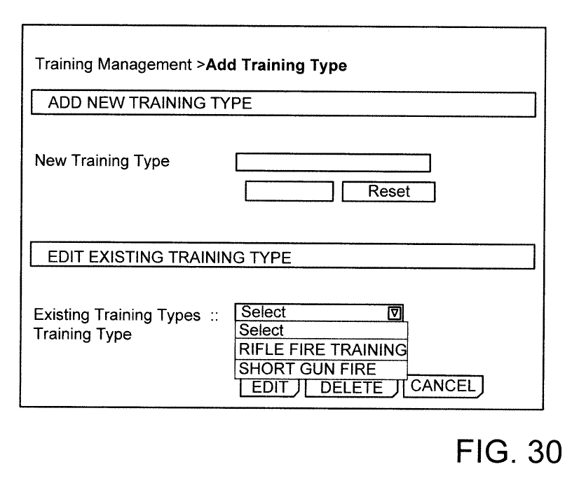

FIG. 30 shows a form used by the graphical user interface for adding or editing a training type. The training types include rifle fire training, and short gun fire.

FIG. 31 shows a form used by the graphical user interface for viewing a log report.

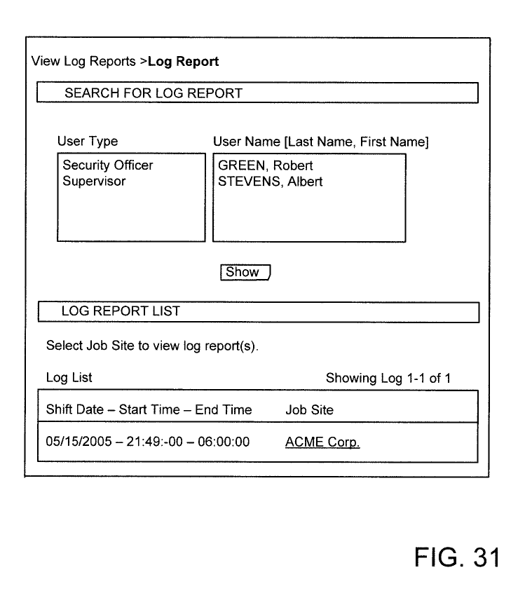

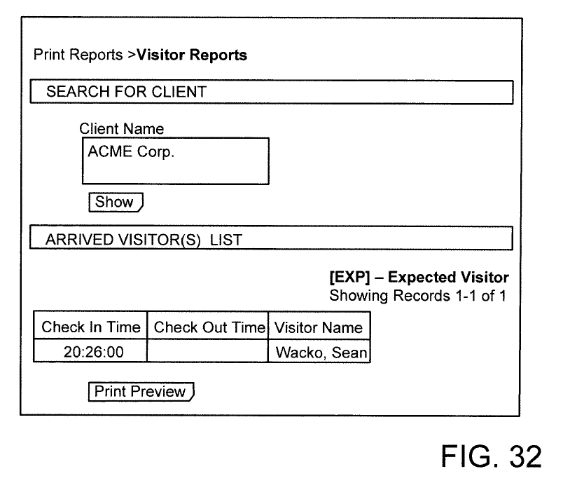

FIG. 32 shows a form used by the graphical user interface for viewing or printing a visitor report

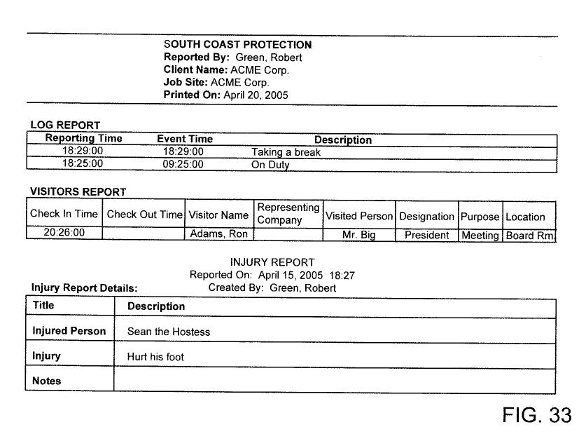

FIG. 33 shows a print-out of various kinds of reports, including a log report, a visitors report, and an injury report.

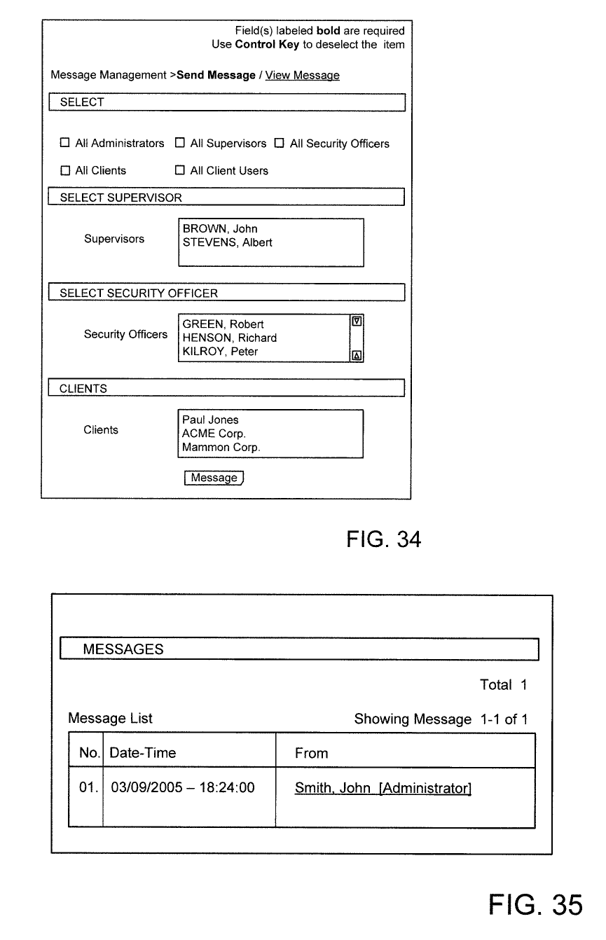

FIG. 34 shows a form used by the graphical user interface for sending a message. The form provides a way of selecting other users of the on-line system to be recipients of the message. The user can click on “view message” to create, edit, or view the message, and can click on “message” at the bottom to send the message.

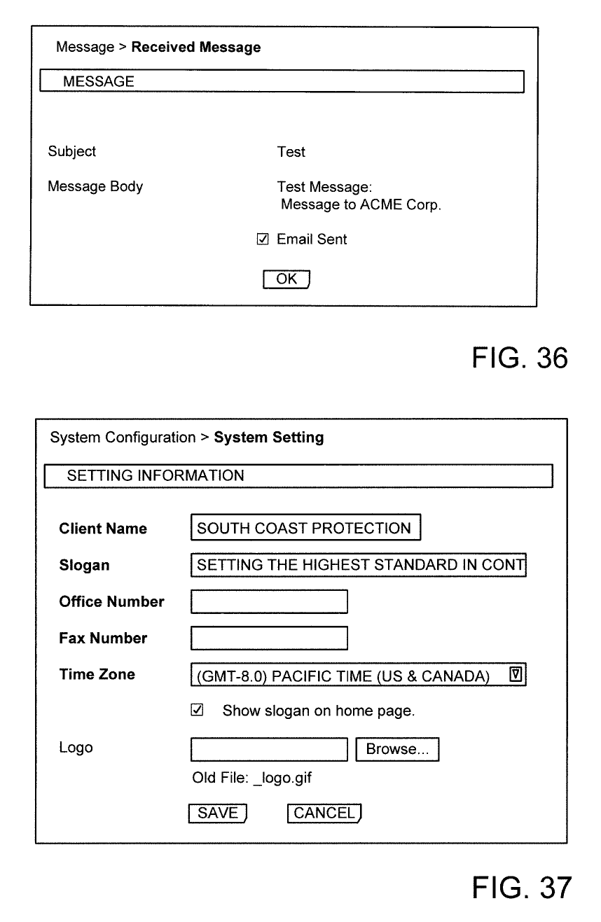

FIG. 35 shows a form used by the graphical user interface for showing a list of messages. The user can click on an item in the list to view a particular message. The message is then displayed, for example, as shown in FIG. 36.

FIG. 37 shows a form used by the graphical user interface for showing a system setting. The system setting includes a client name, slogan, office telephone number, fax number, time zone for the client, and logo. This information is used to set up information that is shown at the top of the display screen in FIG. 8.

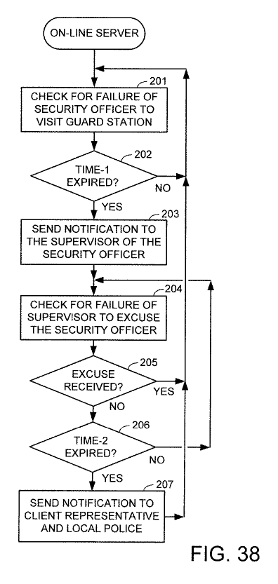

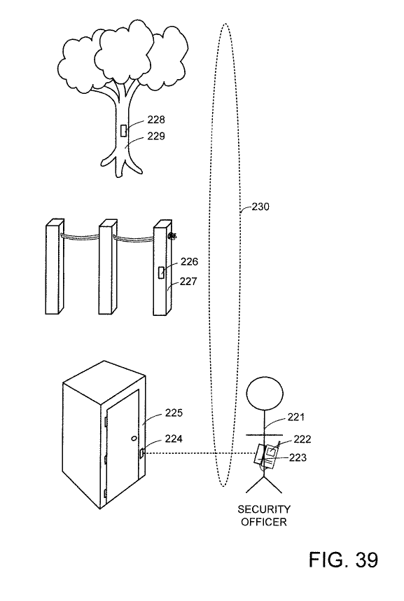

FIG. 38 shows escalation in connection with a call list. In this example, a call list for reporting a failure of a security officer to visit a check point includes the supervisor of the security officer, a client representative, and the local police in the neighborhood of the site being monitored. When there is a failure of the security officer to visit a check point, the supervisor is notified first, without immediately notifying the client representative and the local police. The supervisor is given some time to investigate and possibly excuse the security officer's failure. For example, in step 201, the on-line server checks for a failure of a security officer to visit a check point. In step 202, if the security officer has failed to visit the check point by the expiration of a first scheduled time limit (TIME-1), then execution continues to step 203. In step 203, the on-line server sends a notification of the security officer's failure to the supervisor of the security officer. In step 204, the on-line server checks for a failure of the supervisor to excuse the security officer. For example, the on-line server schedules a second time limit (TIME-2) for the supervisor to send the server a message excusing the security officer before notification of the client representative and the local police, and in step 205 the scheduled event of notifying the client representative and the local police is removed from the list of scheduled events upon receipt of such a message excusing the security officer. If the second time limit expires before such an excuse is received, then in step 206 execution continues to step 207. In step 207, a notification is sent to the client representative and the local police.

The use of escalation in connection with a call list may involve multiple levels and time limits depending primarily on the size and nature of the site being monitored. For example, a security detail at an industrial site could involve multiple levels of supervision over security guards. In such a case, the failure of a security officer to visit a check point could involve a call to the security officer's cell phone, followed by a call to the security officer's supervisor in five minutes if the check point still has not been visited by then, followed by a call to the head of the security detail in ten minutes if the supervisor has not excused the security officer by then, followed by a call to the client representative in ten minutes if the head of the security detail has not excused the supervisor and the security officer. The escalation process could be accelerated if other abnormal conditions are detected at the site. For example, at a site monitored simultaneously by a number of security officers, the escalation process would be accelerated if another one of the security officers would fail to visit a check point at a scheduled time.

As shown in FIG. 1, a client site security system computer is coupled via the Internet to the on-line security management server 21. In this case a high-speed Internet connection provides faster and more reliable communication than a dial-up telephone modem. Many client sites to be monitored, however, do not have a high-speed Internet connection. In these situations, a client site computer will use a dial-up telephone modem or cell phone for communication with the on-line security management server 21.

Some client sites do not have an installed security system computer. In this case, it is possible to program a security officer's cell phone to function as a security system computer. As shown in FIG. 39, for example, the site to be monitored is a construction site. A security officer 221 has an Internet capable cell phone 222 coupled to an RF-ID tag reader 223. RF-ID tags are used to designate check points at the construction site. For example, an RF-ID tag 224 is placed next to a door 225 at the construction site, an RF-ID tag 226 is placed on a fence post 227 at the construction site, and an RF-ID tag 228 is placed on the trunk of a tree 229 at the construction site. Each RF-ID tag is programmed with a unique tag ID that can be read automatically by the tag reader 223 when the security officer 221 is close to the tag.

When the security officer 221 walks his or her round 230, the tag reader 223 detects each tag and sends the respective tag ID to the cell pone 222. Each time that the cell phone receives a tag ID that is different from the last read tag ID, the cell phone reports the new tag ID. The on-line security management server also receives the IP address of the security officer's cell phone 222, and records the time that the tag was read. The cell phone could report the actual time that the tag was read, or the server could estimate the time that the tag was read from the time of receipt of the report from the cell phone 222. In this fashion, the on-line security management server receives a report from the cell pone that a particular security officer has visited a particular check point at a particular time. The server can check for the absence of vitiation of a check point in a specified sequence, or a failure to visit a particular check point by a scheduled time. The server can notify selected parties of missed rounds, late rounds, or any other pre-configured alarm settings.

The RF-ID tag reader 223 can be built into a sleeve or case of the Internet capable cell phone 222. For example, the cell phone is a Nokia 5140 cell phone and the RF-ID tag reader is part of a case that receives the Nokia 5140 cell phone. Such a cell phone having a built-in RF-ID tag reader is supplied by Avnet, Inc., 2211 South 47th Street, Phoenix, Ariz. 85034. The RF-ID tag reader will read the tag when the tag reader touches the tag.

The sensitivity of the tag reader can be set to read the tag when the tag reader is placed within a certain number of inches of the tag. In practice, it is desirable for the tags to be placed at a height of about five feet above the ground, and for the tag reader to be set to read a tag only when the tag reader is closer than about twelve inches from the tag. In this fashion, a security office can walk past a tag and the tag will be read and reported to the on-line server only when the security officer intentionally raises the tag reader and cell phone off his or her belt and places the tag reader up close to the tag. This permits the tag reader and cell phone to be turned on whenever the security officer is at a site without sending a confusing report when the security officer enters or leaves the site during a shift change.

The security officer can also use the cell phone 222 to send voice clips and text messages to the on-line server. The cell phone 222 may also have a built-in camera that can be used to send pictures or short movies of the site to the on-line server. The voice clips, text messages, pictures, and movies, could be combined with additional information read from the tags, such as a name or street address of the site. These data can be stored in a database in the server for viewing, edited, and copying by the security guard or a supervisor when needed for creating reports related to activities or incidents at the site.

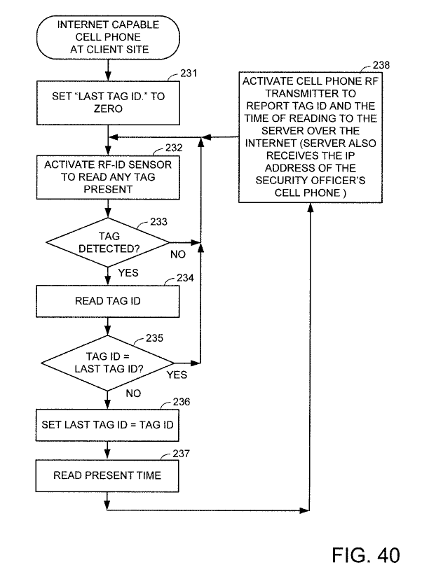

FIG. 40 shows programming of a security officer's Internet capable cell phone so that the cell phone will function as a client site security system computer. In a first step 231, the processor in the cell phone sets a variable called “last tag ID” to zero. Then in step 232, the cell phone activates the RF-ID tag sensor to read any tag present. In step 233, if a tag is detected, then execution continues to step 234. Otherwise, execution loops back to step 232 to activate the RF-ID tag sensor on a periodic basis until a tag is detected.

In step 234, the cell phone reads the tag ID from the tag reader. In step 235, the processor in the cell pone compares the tag ID read from the tag reader to the tag ID stored in the variable “last tag ID”. If the tag ID read from the tag reader is the same as the tag ID stored in the variable “last tag ID”, then execution loops back to step 232 to periodically activate the RF-ID tag sensor. Once the tag ID read from the tag reader is different from the tag ID stored in the variable “last tag ID”, execution continues from step 235 to step 236. In step 236, the processor in the cell phone sets the variable “last tag ID” equal to the tag ID just read from the tag reader. In step 237, the processor in the cell phone reads the present time from its internal clock. In step 238, the cell phone computer activates the cell phone RF transmitter to report the tag ID and the time of reading the tag (from step 237) over the Internet to the on-line security management server. The on-line security management server also receives the security officer's IP address.

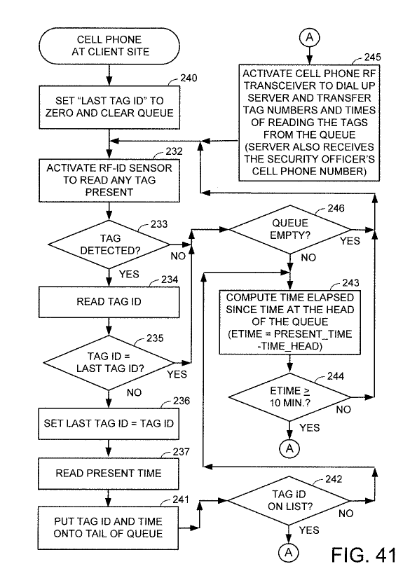

It is preferred to use an Internet capable cell phone for communication between the tag reader and the on-line server. This permits short digital messages to be sent quickly between the cell pone and the on-line server, without the delay of dialing-up the server. It is possible, however, to use a cell phone that dials-up the server, for example, if there would be a temporary loss of Internet service. In this case, the cell phone could dial-up the on-line server each time that a tag is read, but the use of a rather large number of tags at a site would cause the cell phone to make frequent calls to the server. The frequency of calls to the server could be reduced by the cell phone queuing tag IDs and tag reading times as the tags are detected, and calling the server to report the content of the queue at a limited frequency or when the security officer visits particular check points designated by particular tag IDs. This is demonstrated by the program shown in FIG. 41.

In a first step 240, the variable “last tag ID” is set to zero, and also a queue is cleared. The following steps 231 to 237 in FIG. 41 are the same steps 231 to 237 used in FIG. 40. Then in a step 241, the tag ID and present time (read in step 237) are put onto the tail of a queue. In step 242, the tag ID is compared to a list of tag IDs that should be immediately reported to the server. Alternatively, in step 242, the tag ID could be compared to a certain range of tag IDs, or otherwise decoded (for example by comparison to a pre-determined bit mask) to determine if the tag ID should be immediately reported to the server.

If the tag ID is not to be immediately reported to the server, then execution continues from step 242 to step 243. In step 243, the time elapsed since the time in the entry at the head of the queue is computed, for example, by subtracting the time in the entry at the head of the queue from the present time provided by the cell phone's clock. In step 244, if the elapsed time is not greater than or equal to ten minutes, then execution loops from step 244 back to step 232. If the elapsed time is greater than or equal to 10 minutes, then execution continues to step 245 to activate the cell phone RF transceiver to dial up the server and to transfer the tag IDs and times of reading the tags from the queue. The server also receives the security officer's cell phone number. In this fashion, the content of the queue is dumped to the server with a delay in reporting the tag ID that is no more than about 10 minutes plus the time to make the cell pone call to the server. After step 245, execution continues to step 232.

In step 242, if the tag ID should be immediately reported to the server because the tag ID is on the list, then execution branches from step 242 to step 245 in order to dump the queue to the on-line server.

In view of the above, there has been described a method of using RF-ID tags for tracking a person such as security officer at a construction site. A respective RF-ID tag is placed at each of a plurality of locations at the site. Each RF-ID tag has a tag identifier identifying the location at which it is placed. The person carries a portable RF-ID tag reader while visiting at least some of the locations, and the portable RF-ID tag reader detects the presence of the RF-ID tag at these locations and reads the tag identifiers identifying these locations. The person is tracked by monitoring a sequence of the tag identifiers read by the portable RF-ID tag reader. For example, the person also carries an Internet capable cell telephone coupled to the portable RF-ID tag reader. The cell telephone transmits the tag identifiers over the Internet to a computer remote from the site, and the computer detects when the person deviates from an assigned path at the site.

1. A method of tracking a person, said method comprising:
placing an RF-ID tag at each of a plurality of locations, the RF-ID tag at each of the plurality of locations having a tag identifier identifying said each of the plurality of locations;
the person carrying a portable RF-ID tag reader while visiting at least some of the locations, the portable RF-ID tag reader detecting the presence of the RF-ID tags at said at least some of the locations and reading the tag identifiers identifying said at least some of the locations, and
monitoring a sequence of the tag identifiers read by the portable RF-ID tag reader in order to track the person.

2. The method as claimed in claim 1, which includes detecting that the sequence of the tag identifiers read by the RF-ID tag reader fails to match a predetermined sequence.

3. The method as claimed in claim 1, which includes detecting that the person fails to visit at least one of the locations by a predetermined time.

4. The method as claimed in claim 1, which includes recording each of said at least some of the tag identifiers in association with a respective time at which said each of said at least some of the tag identifiers were read by the portable RF-ID tag reader.

5. The method as claimed in claim 1, wherein the person also carries a portable wireless transmitter for transmitting each of said at least some of the tag identifiers to a computer that monitors the sequence of the tag identifiers read by the RF-ID tag reader in order to track the person.

6. The method as claimed in claim 1, wherein the person also carries a cell telephone coupled to the RF-ID tag reader for transmitting each of said at least some of the tag identifiers to a computer that monitors the sequence of the tag identifiers read by the RF-ID tag reader in order to track the person.

7. The method as claimed in claim 6, wherein the cell telephone is an Internet capable cell telephone, and the method includes transmitting said each of said at least some of the tag identifiers from the cell telephone over the Internet to the computer that monitors the sequence of the tag identifiers read by the RF-ID tag reader in order to track the person.

8. The method as claimed in claim 6, wherein the cell telephone repetitively dials-up the computer to transmit groups of said at least some of the tag identifiers.

9. The method as claimed in claim 6, wherein the cell telephone repetitively dials-up the computer to transmit groups of consecutive ones of said at least some of the tag identifiers and the respective times at which the consecutive ones of said at least some of the tag identifiers were read by the RF-ID tag reader.

10. The method as claimed in claim 1, wherein the plurality of locations are at a site, and the method includes transmitting the sequence of the tag identifiers read by the portable RF-ID tag reader to a computer remote from the site, and the computer remote from the site detecting when the person deviates from an assigned path at the site.

11. A method of employing a security officer at a site, said method comprising:
placing an RF-ID tag at each of a plurality of locations at the site, the RF-ID tag at said each of the plurality of locations having a tag identifier identifying said each of the plurality of locations;
the security officer carrying a portable RF-ID tag reader while visiting at least some of the locations, the portable RF-ID tag reader detecting the presence of the RF-ID tags at said at least some of the locations and reading the tag identifiers identifying said at least some of the locations; and
using a computer to monitor a sequence of the tag identifiers read by the portable RF-ID tag reader.

12. The method as claimed in claim 11, which includes the computer detecting that the sequence of the tag identifiers read by the RF-ID tag reader fails to match a predetermined sequence.

13. The method as claimed in claim 11, which includes the computer detecting that the security officer fails to visit at least one of the locations by a predetermined time.

14. The method as claimed in claim 11, which includes recording each of said at least some of the tag identifiers in association with a respective time at which said each of said at least some of the tag identifiers were read by the portable RF-ID tag reader.

15. The method as claimed in claim 11, wherein the security officer also carries a portable wireless transmitter for transmitting each of said at least some of the tag identifiers to the computer.

16. The method as claimed in claim 11, wherein the security officer also carries a cell telephone coupled to the RF-ID tag reader for transmitting each of said at least some of the tag identifiers to the computer.

17. The method as claimed in claim 16, wherein the cell telephone is an Internet capable cell telephone, and the method includes transmitting said each of said at least some of the tag identifiers from the cell telephone over the Internet to the computer.

18. The method as claimed in claim 16, wherein the cell telephone repetitively dials-up the computer to transmit groups of said at least some of the tag identifiers.

19. The method as claimed in claim 16, wherein the cell telephone repetitively dials-up the computer to transmit groups of consecutive ones of said at least some of the tag identifiers and the respective times at which the consecutive ones of said at least some of the tag identifiers were read by the RF-ID tag reader.

20. The method as claimed in claim 11, wherein the computer is remote from the site, and the computer detects when the security officer deviates from an assigned path at the site.

21-26. (canceled)

27. Apparatus for tracking a person comprising a portable RF-ID tag reader and a cell telephone for carrying by the person while the person walks along a path including RF-ID tags at respective locations, the RF-ID tag reader being coupled to the cell telephone for transmitting tag identifiers to the cell telephone, the cell telephone being programmed for transmitting the RF-ID tag identifiers to a computer programmed for monitoring the tag identifiers received from the cell telephone in order to track the person.

28. The apparatus as claimed in claim 27, wherein the cell telephone is an Internet capable telephone for transmitting the RF-ID tag identifiers over the Internet to the computer.

29. The apparatus as claimed in claim 27, wherein the cell telephone is programmed to repetitively dial-up the computer to transmit groups of the tag identifiers received from the RF-ID tag reader.

30. The apparatus as claimed in claim 27, wherein the cell telephone is programmed to repetitively dial-up the computer to transmit groups of consecutive ones of the tag identifiers received from the RF-ID tag reader and the respective times at which the consecutive ones of the tag identifiers were read by the RF-ID tag reader.

31. The apparatus as claimed in claim 27, further comprising the computer in combination with the RF-ID tag reader and the cell telephone.

32. The apparatus as claimed in claim 27, further comprising the computer in combination with the RF-ID tag reader and the cell telephone, the computer being programmed to monitor the RF-ID tag identifiers received from the cell telephone to detect when the person deviates from the path.
